(19) United States
(12) Patent Application Publication
(10) Pub. No.: US 2012/0078781 A1
(43) Pub. Date: Mar. 29, 2012

(54) Automatic Bill-Pay Setup

(75) Inventors: Erik S. Ross, Charlotte, NC (US); Susan S. Thomas, Gastonia, NC (US)

(73) Assignee: Bank of America Corporation, Charlotte, NC (US)

(21) Appl. No.: 12/890,875

(22) Filed: Sep. 27, 2010

(51) Int. Cl. G06Q 40/00

(52) U.S. Cl. 705/40

(57) ABSTRACT

A system and method of automatically setting up bill-pay transactions between a customer of a financial institution and a bill-pay client is presented. The system and method may include identifying, by a bill-pay system associated with the financial institution, one or more customers eligible for automatic bill-pay set up and one or more bill-pay clients. Upon acceptance of an offer to the customer to automatically setup bill-pay, bill-pay transaction data may be received at a bill-pay system and may be used to set up one or more bill-pay transactions between the customer and the bill-pay client.

### BACKGROUND

In today's fast-paced world, people are always looking for ways to save time, work more efficiently, save money, etc. Accordingly, electronic bill-pay has become a popular alternative to payment of bills via mail, payment at a store or municipal building, etc. Electronic bill-pay provides convenience in allowing users to pay several bills from their computer, such as via electronic funds transfer from a financial institution, in order to save time associated with writing checks, addressing envelopes, mailing checks, etc. However, electronic bill-pay often requires a user, such as a customer, to set up the bill-pay process (e.g., input an account number associated with the bill, input a name on the bill, input a bank account number for payment of the bill, etc.). This may be somewhat time consuming and inefficient. Accordingly, a system and method of automatically setting up the bill-pay process would be advantageous.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, a system and method of automatically setting up bill-pay transactions between a customer associated with a financial institution and a bill-pay client is presented. In some examples, a bill-pay identification system associated with the financial institution may identify a customer of the financial institution (such as individuals having accounts, loans, etc. through the financial institution) that may be eligible for bill-pay. The user may be prompted to accept or reject a proposed automatic setup of bill-pay between the customer and one or more potential bill-pay clients. Upon accepting the option to automatically setup bill-pay, customer data, such as an account identifier associated with an account at the financial institution, name of customer, etc. may be transferred to a bill-pay system (e.g., from the bill-pay identification system to the bill-pay system), along with information associated with the bill-pay client. In some examples, default bill-pay settings will be implemented, such as payment from a default account (such as a checking account), payment of a full amount of a bill due the entity by the customer, etc. In other arrangements, bill-pay settings may be based on bill-pay transaction information received from existing bill-pay relationships between other customers of the financial institution and the one or more bill-pay clients. In still other examples, bill-pay settings and transaction information may be received from a scan or photograph of a bill associated with the customer and the bill-pay client.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example system for automatically setting up bill-pay transactions between a customer of a financial institution and an entity associated with the customer according to one or more aspects described herein.

FIG. 3 illustrates one example method of automatically setting up bill-pay transactions between a customer of a financial institution and one or more bill-pay clients associated with the customer according to one or more aspects described herein.

FIG. 4 illustrates one example user interface for accepting/rejecting the proposed automatic bill-pay setup according to one or more aspects described herein.

FIG. 5 illustrates example default settings for use with automatic bill-pay setup according to one or more aspects described herein.

FIG. 6 illustrates one example user interface for adjusting bill-pay settings according to one or more aspects described herein.

FIG. 7 illustrates one example user interface for scanning a bill in order to complete a bill-pay setup process according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

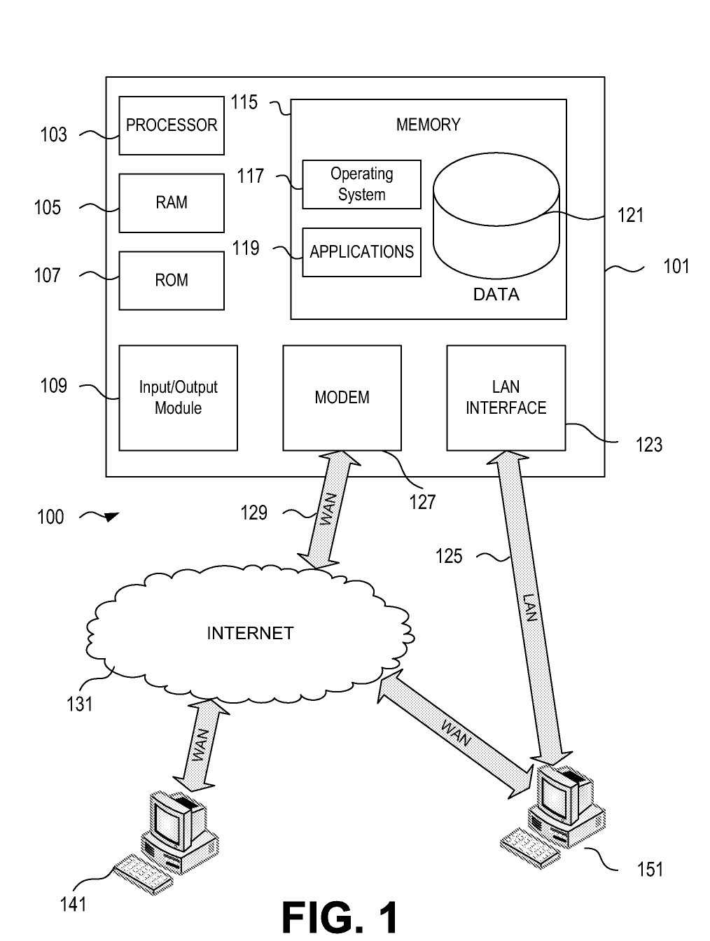

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The above-described systems may be used in various financial institutions, such as banks, etc., and may be used to identify various customers that may be eligible for automatic setup of bill-pay with various bill-pay clients. For instance, the financial institution may identify one or more customers that may be eligible for bill-pay. The financial institution may then identify potential bill-pay clients associated with the institution's customers. For instance, the financial institution may identify various bill-play clients and offer to automatically set up bill-pay with one or more of those bill-pay clients via the financial institution. In some examples, bill-pay clients may include a variety of clients, including a utility company (e.g., gas, water, electric, telephone, etc.), cable company, grocery, retailer, dry cleaner, water delivery company, newspaper delivery company, and the like. If the customer accepts the offer to set up bill-pay, the bill-pay arrangements may be set up, in some instances, without any further input or interaction with the customer.

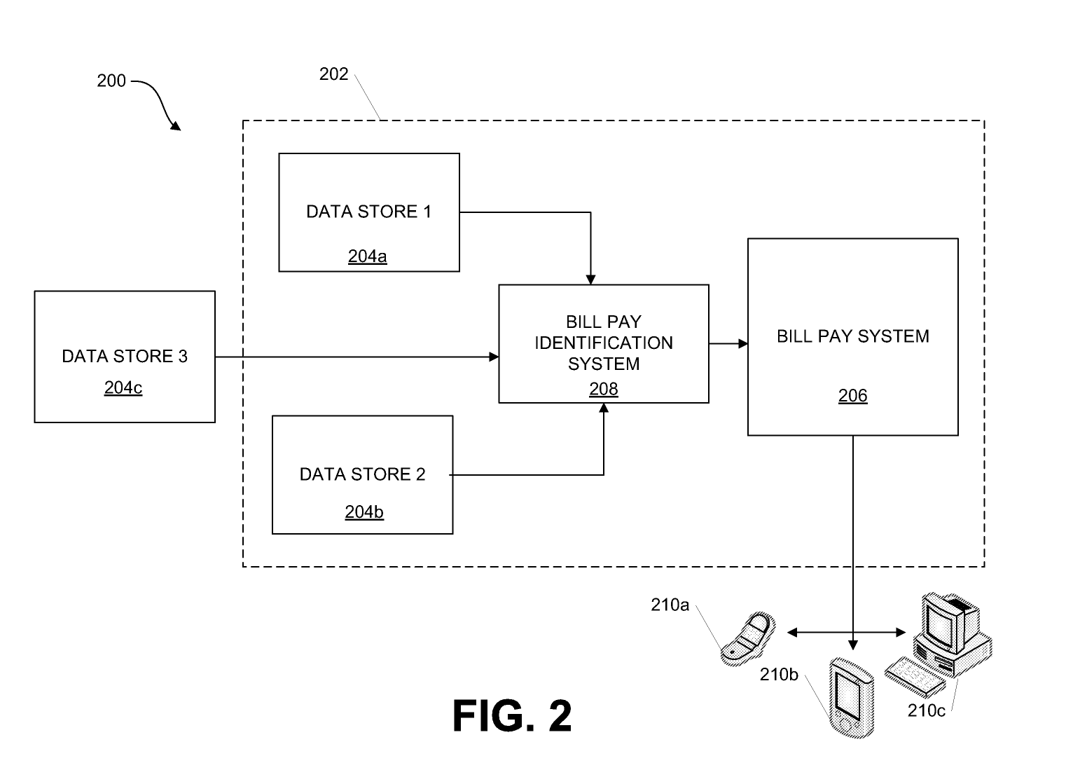

FIG. 2 illustrates one example system for identifying potential automatic bill-pay customers and bill-pay clients. The system 200 may include a financial institution 202. In some arrangements, the customers may be associated with the financial institution 202. For instance, a customer may have one or more accounts at the financial institution 202 (e.g., checking accounts, savings accounts, money market accounts, etc.) or may hold a loan with the financial institution (e.g., a mortgage, auto loan, home equity loan or line or credit, etc.). The system 200 may also include one or more data storage systems 204a-204c, such as databases, etc. The data storage systems 204a-204c may be internal to or associated with the financial institution 202, such as data storage systems 204a and 204b. Additionally or alternatively, the data storage systems 204 may be external to the financial institution 202, such as data storage system 204c. For instance, a data storage system (e.g., data storage system 204c) external to the financial institution 202 may be a data system that stores information related to customers of the financial institution but does not necessarily store information related to the financial institution itself, or dealings (e.g., accounts, account numbers, loans, etc.) between the financial institution and the customer.

The financial institution 202 may also include a bill-pay identification system 208. The bill-pay identification system 208 may receive data from the data storage systems 204 and process it to determine various entities or bill-pay clients that may be available/eligible for bill-pay with various customers. For instance the bill-pay identification system 208 may receive information regarding various bill-pay clients in an area (e.g., a geographic area) associated with a customer. In some examples, identification of these entities may be based on a home address of the customer and information about the bill-pay clients servicing that area, as will be discussed more fully below. In some instances, the automatic bill-pay may be initiated by a customer or customer action, such as opening a new account with the financial institution. In other instances, the bill-pay setup may be initiated based on a customer signing up for bill-pay for a service and then the automatic bill-pay system may offer additional bill-pay options to other bill-pay clients.

In some examples, the bill-pay identification system 208 may also identify likely or probable recurring and/or non-recurring payments for applicable bill-pay setup with the user, such as credit cards, mortgage, auto loan, etc. Identification of these bill-pay opportunities may be performed in various ways, as will be discussed more fully below.

The bill-pay identification system 208 may present identified bill-pay options to customers of the financial institution that may permit automatic bill-pay setup. For example, identified bill-pay options may be presented to a customer via a bill-pay system 206. If the customer desires to proceed with the offered bill-pay options, a customer may provide any additional information to set up the bill-pay process to the bill-pay system or, in some examples, the stored information may be automatically used set up the electronic bill-pay, as will be discussed more fully below.

The bill-pay system 206 may include one or more user devices 210a-210c, which can come in any variety of forms. User devices 210a-210c may include, for example, a mobile device 210a (including a cell phone, smart phone, wearable computing device, etc.), personal digital assistant (PDA) 210b, and/or computer terminal 210c (which may be a desktop, laptop, etc.). Customers may access the bill-pay system 206 via one or more of these devices 210a-210c in order to confirm payment, provide additional information to the system as needed, revise payment options such as date of payment, amount of payment, enter manual notes, etc. In some examples, a mobile device may be used to facilitate setup, as will be discussed more fully below.

As mentioned above, the bill-pay identification system 208 may look at customers within a geographic area, such as a city, town, village, subdivision, etc. and may use that information to identify bill-pay clients or options that may be desirable to others within the geographic location or even outside the geographic location. In other examples, the bill-pay identification system 208 may use demographic information associated with the customer to identify potential bill-pay clients. In still other examples, the bill-pay identification system 208 may use information obtained from a merchant, vendor, retailer, etc. (e.g., from a current or previous transaction, from a location of a customer, etc.) to identify potential bill-pay clients. In yet other examples, potential bill-pay clients and/or information for bill-pay setup may be obtained via social networking sites, such as FACEBOOK, TWITTER, etc. Each of these arrangements will be discussed more fully below.

In some examples, the financial institution 202 may be able to obtain information regarding bill-pay clients that offer services in a geographic location near a customer based on an address the customer has provided to the financial institution. For instance, the bill-pay identification system 208 may use a look-up feature based on a zip code of a customer of the financial institution, a zip code+4 of a customer, etc. Potential bill-pay clients within the zip code, a predefined distance from the zip code (e.g., 10 miles, 25 miles, etc.), etc. may be identified and bill-pay setup with one or more of the identified bill-pay clients may be offered to customers. In some instances, the look-up may be performed for existing bill-pay customers (e.g., customers of the financial institution currently using bill-pay for one or more bills) and may identify additional bill-pay opportunities within the area for those individuals. For instance, based on the zip code of the current bill-pay user, additional bill-pay clients within the zip code, or predefined distance from the zip code, that the current user may not be taking advantage of (e.g., as a local grocer, local dry cleaner, local child care provider, newspaper delivery service, etc.) may be identified for the existing customer.

Additionally or alternatively, the system described herein may be utilized to provide additional bill-pay options to new or limited customers of the financial institution's bill-pay service. In this regard, bill pay opportunities may be identified to new or limited use customers based on existing bill pay clients of other customers within the same geographic region. For example, the zip code of a current bill-pay user may be used to identify a plurality of vendors eligible for bill-pay. Again, these identified vendors may include local merchants, service providers, etc., such as utility companies, dry cleaners, restaurants, child care providers, cleaning services, etc. Other potential bill-pay customers may then be identified based on the zip code information (e.g., customers of the financial institution not utilizing bill-pay but living in or near the zip code region) and an offer of automatic bill-pay setup may be made to those customers for one or more of the identified vendors. Additional options may be offered, such as one or more credit cards may be identified as potential bill-pay opportunities based on the popularity of the card within or near the identified zip code, etc.

For example, the financial institution 202 may receive an address associated with Customer 1 in Anytown, USA. The financial institution 202 may then request information from various data storage systems, such as systems 204 that may be internal and/or external to the financial institution, that may include a listing of bill-pay clients in Anytown, such as merchant 1, electric company 1, gas company 1, phone company 1, etc. The same or similar information may be gathered for other types of bill-pay clients specific to the customer's geographic location such as cable companies, local service providers, local vendors or merchants, etc. Identification of these bill-pay clients may be based on bill-pay relationships between the bill-pay clients and other customers of the financial institution (e.g., other than Customer 1), within or near to Anytown, USA. This information may be stored external to the financial institution 202 and may be requested by the financial institution upon establishing a relationship with a client (such as opening an account, obtaining a mortgage, etc.). The obtained information may be used to provide bill-pay services to Customer 1, as will be described more fully below.

In some arrangements, the geographic information obtained may be based on a relatively small area near an address of the customer, such as a subdivision in which the customer lives. The bill-pay identification system 208 may identify bill-pay clients offering services used by customers within the subdivision (e.g., dry cleaning, day care, water deliver service, cable, etc.) and may cross-reference that information with other customers of the financial institution within the subdivision. Those customers may then be offered an opportunity for bill-pay for the identified bill-pay clients.

The identification of bill-pay clients may, in some instances, be part of an unrelated service provided by the financial institution. For instance, a customer may apply for and receive a mortgage at a financial institution. Once the mortgage is finalized, the financial institution may use information received from the customer, such as address of the home having the mortgage, to identify utility companies and other potential automatic bill-pay clients associated with that geographic region. The financial institution may then offer to automatically set up bill-pay with those bill-pay clients as a service to the customer taking out the mortgage with the financial isntitution. This may aid the customer in transitioning to the new home, save time in paying bills, etc.

As mentioned above, demographic information and/or characteristics of a customer may also be used in identifying bill-pay clients. For instance, customers having an income above a predetermined level may be identified as potential users of bill-pay for one or more vendors or other bill-pay clients. The bill-pay clients may be within a geographic area. Additionally or alternatively, a customer identified as having children may be offered bill-pay opportunities at a bill-pay client such as a day-care center.

In still other examples, the bill-pay identification system 208 may use information obtained from a merchant, vendor, retailer, etc. to identify potential bill-pay clients. For instance, a mobile device having a global positioning system (GPS) or other location identifying information may be used to determine a location of a customer at a merchant, vendor, etc. The presence of the customer at the identified merchant, vendor, etc. may then prompt the merchant or vendor to be identified as a potential bill-pay client and a bill-pay option may be offered to the customer. In some examples, the offer may be provided via a mobile device (e.g., web banking application on a smart phone) or may be transmitted via email, SMS, etc. to the user who may then accept or decline the offer to automatically set up bill-pay with the retailer. In some instances, data associated with bill-pay may be obtained and stored while the user is within the environment, such as via a mobile device, NFC, etc., and may be used to set up bill-pay if the user accepts the offer of automatic bill-pay set up, as will be discussed more fully below.

Additionally or alternatively, completing a transaction with a vendor, merchant, retailer, etc. may trigger identification of the vendor, merchant, retailer, etc. as a potential bill-pay client. For instance, a user may complete an online transaction with a merchant using a debit or credit card associated with the financial institution. The financial institution may then identify the merchant as a potential bill-pay client and offer automatic bill-pay setup to the customer based on this identification.

In yet other examples, potential bill-pay clients and/or information for bill-pay setup may be obtained via social networking sites, such as FACEBOOK, TWITTER, etc. For example, a customer may be connected with one or more other individuals via a social networking site. One or more bill-pay clients associated with the individuals may be identified and offered as bill-pay options to the customer. This may allow for targeted identification of bill-pay clients based on common interests, etc. of the customer and the individuals with which he or she is associated.

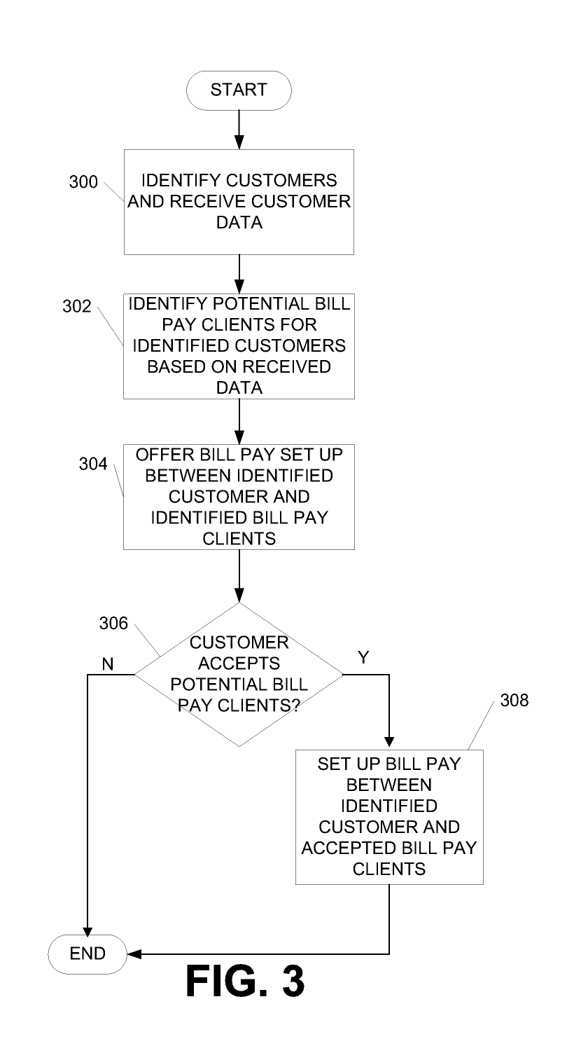

FIG. 3 illustrates one example method of providing automatic bill-pay setup. In step 300, customers eligible for automatic bill pay are identified. These customers may be individuals, etc. associated with the financial institution at which bill-pay may be implemented. In some examples, eligibility may require that the customer have an account (such as a checking, savings, money market, etc. account) with the financial institution. In other examples, eligibility may require a relationship between that customer and the financial institution meeting a predetermined threshold of time. For instance, a customer may be eligible for automatic bill-pay setup upon having an account, loan, mortgage, etc. at the bank for at least a year, six months, two years, etc. Alternatively, bill-pay features may be gradually expanded as the relationship between the customer and the financial institution develops (e.g., over time, increase opening of accounts, deposits, usages of services, etc.).

In step 302, one or more bill-pay clients are identified. As discussed above, bill-pay clients may be identified based on a geographic location, previous transaction with the customer, etc. In step 304, the option to automatically sign up for bill-pay is provided to a customer. This offer may include one or more bill-pay clients deemed eligible for bill-pay. In step 306, a determination is made as to whether the user accepts the offered bill-pay option. If the user accepts, the bill-pay will be set up between the customer and the identified bill-pay clients in step 308. Bill-pay set up may include initiation of a test transfer of funds and/or requesting authorization for transferring funds to (or from) a financial account associated with the billing entity. In some examples, bill-pay may be for a recurring or periodic payment (such as a monthly bill or loan payment). In some examples, user acceptance of the offered bill-pay option may be the only user input needed to complete bill-pay set up. For example, the financial institution may rely on default settings for bill-pay or other information associated with the customer and may automatically set up bill-pay between the customer and the desired bill-pay clients, as will be discussed more fully below. Additionally or alternatively, a user may have additional input in the bill-pay setup process, as will be discussed more fully below.

Although the example method in FIG. 3 may include identification of a plurality of bill-pay clients offered to the customer for acceptance and bill-pay setup together, in other examples, one or more bill-pay client may be identified and offered to the client individually for acceptance and/or setup.

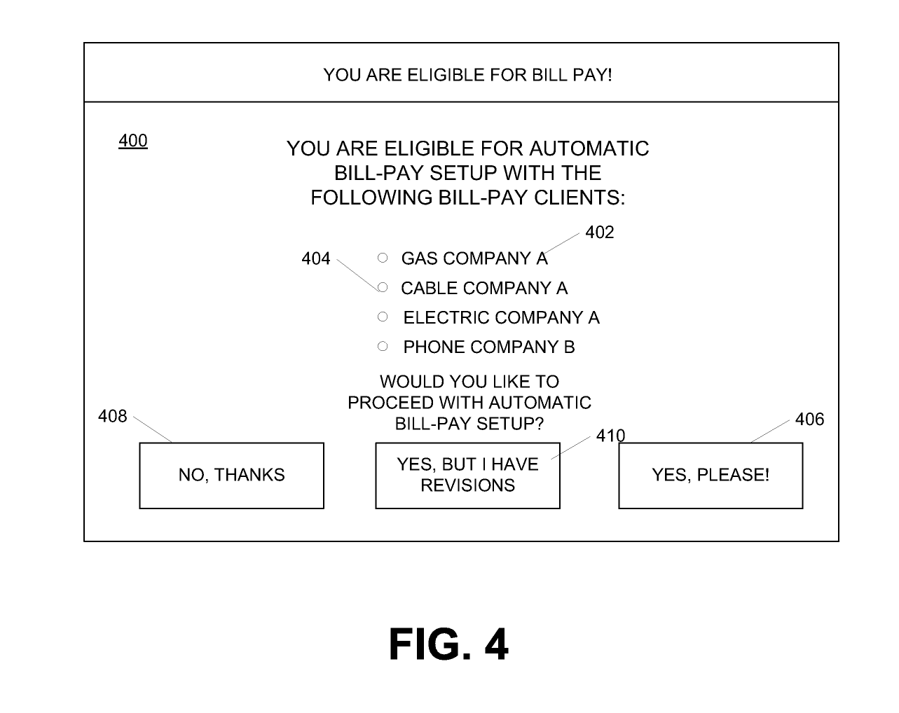

FIG. 4 illustrates one example user interface 400 for offering automatic bill-pay setup to a customer. In some examples, the example interface 400 may be provided to a customer upon logging in to an online banking system or upon accessing a website associated with the financial institution. In some examples, the user interface 400 may be a pop-up interface provided to the customer during the course of an online banking transaction, etc. that may be unrelated to bill-pay. The interface 400 includes a plurality of bill-pay clients eligible for bill-pay with the customer in field 402. In the example shown, each identified bill-pay client includes a radio button 404 that may be selected in order to set up bill-pay with that entity. Alternatively, the bill-pay clients may be provided in a list or drop-down menu that may provide for selection by clicking or double clicking (or otherwise interacting with) the desired entity, etc. The user interface 400 may include a “no, thanks” option 408 that may reject the offered bill-pay setup and the customer may move on to another interface. When a customer has selected the desired bill-pay clients and desires to move forward with automatic bill-pay setup, the customer may select “yes, please!” option 406. In some examples, selection of this option may automatically set up bill-pay between the customer and the selected entities, as will be discussed more fully below.

Automatic setup of bill-pay for a customer choosing to proceed with bill-pay for identified bill pay clients may be performed in several ways. For instance, various default settings may be used or implemented. In other examples, some default settings may be used while some user input may be involved. In other examples, bill-pay setup information may be obtained from a photograph or scanned image of a bill associated with the bill-pay client. In still other examples, GPS or other location information may be used to obtain bill-pay setup information. Other examples may include obtaining bill-pay setup information from current or previous transaction information obtained during a transaction between the customer and a vendor, merchant, retailer, etc. and/or from social networking sites.

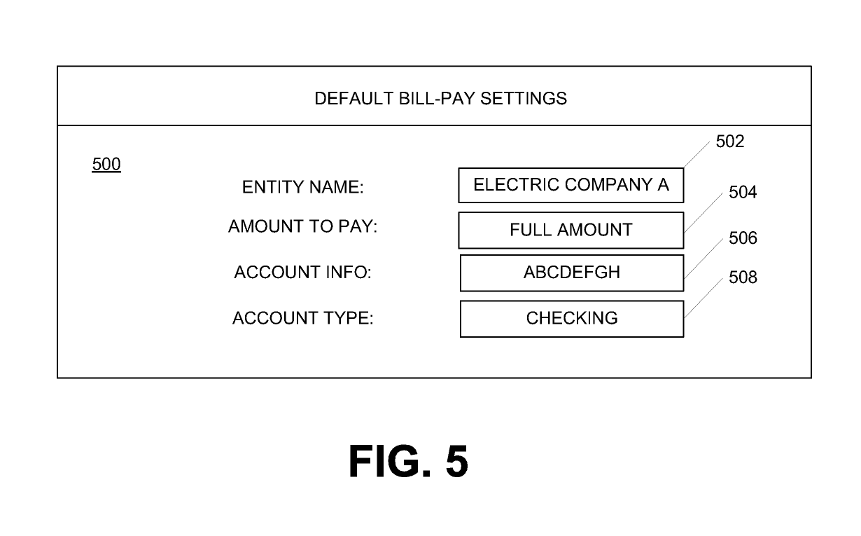

FIG. 5 illustrates a listing of some example default settings that may be used with automatic bill-pay setup. The listing 500 includes the name of the entity with which bill-pay is being set up in field 502. Field 504 indicates a default amount to pay. In this example, the default amount is a full amount of a bill associated with the customer. In other examples, such as with payment of a term loan, the monthly payment due may be the default amount. The payment amount may be a recurring payment. Field 506 indicates an account number associated with the client that may be used for payment via the bill-pay system and field 508 indicates the type of account. Although the listing 500 includes example default arrangements, additional information may also be provided in the default settings, as desired.

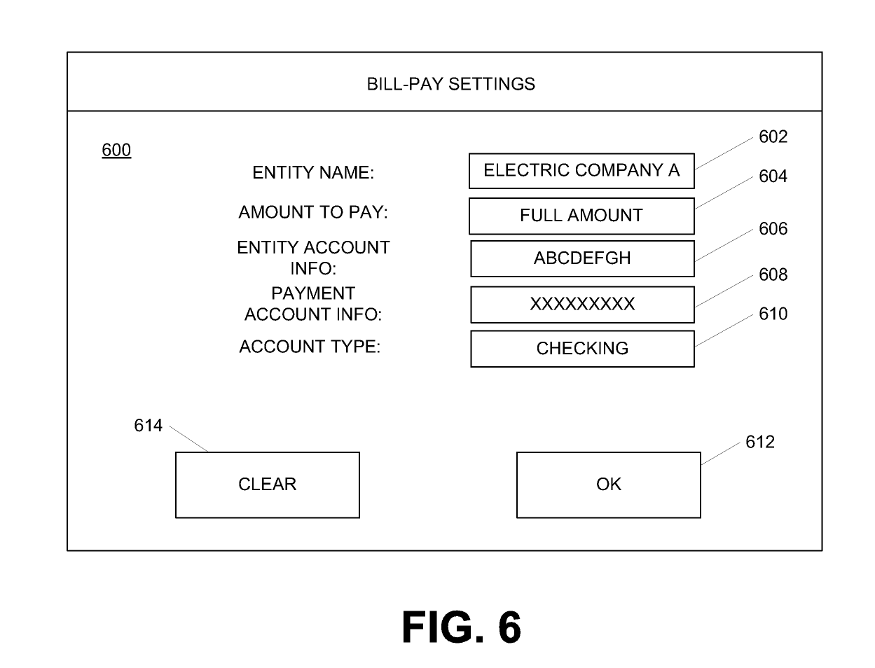

With further reference to FIG. 4, a customer may also select “yes, but I have revisions” option 410. This option may allow a customer to accept the offered bill-pay options and may implement some defaults settings, but may further allow the customer to provide input regarding settings for bill-pay. FIG. 6 illustrates one example user interface 600 in which a user may adjust or alter the bill-pay settings. In field 602, a user may input the entity with which bill-pay is being set up. In field 604, the amount of a payment may be input. Field 606 allows a user to input account information associated with a customer account at the bill-pay client to which the payment is being made. For instance, the user may input his or her account information for an account with the electric company, gas company, etc.

Fields 608 and 610 include the payment account number and type of account, respectively. The payment account may be an account held at or associated with the financial institution. The user interface 600 also includes an “ok” option 612. Selection of this option may process the information input and may establish the bill-pay relationship between the customer and the desired entity. Alternatively, clear option 614 is provided. Selection of this option may clear all information input into the interface 600.

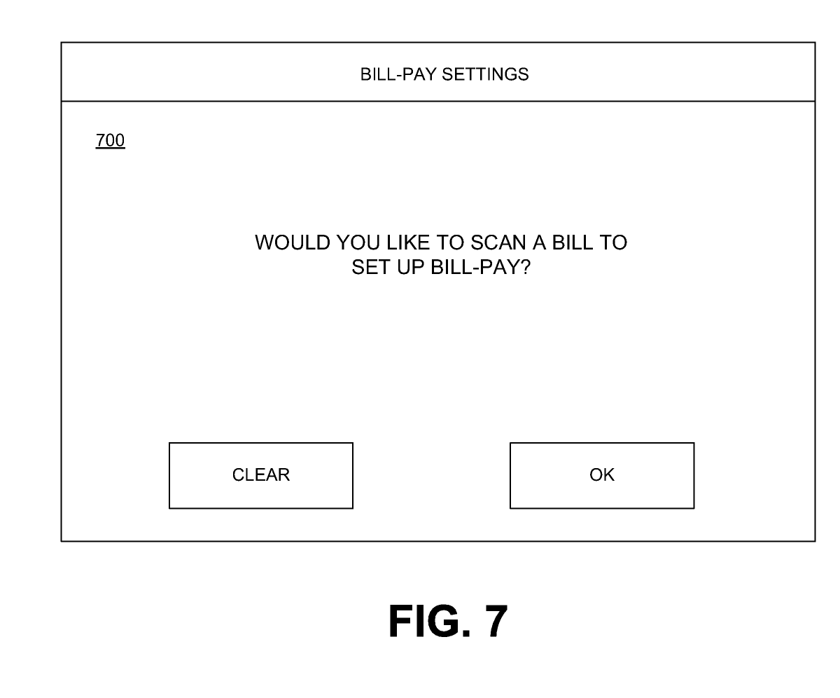

As mentioned above, a photograph or scan of a customer bill from a bill-pay client may be used to obtain bill-pay setup information. For example, a user may be prompted to scan in a bill received from the bill-pay client in order to provide the needed information (e.g., address, name, financial account number, etc.) to complete an electronic bill-pay transaction. FIG. 7 illustrates one example user interface 700 in which a user is prompted to scan in or take a photograph of a bill, such as a utility bill. The scan or photo of the bill may be parsed to identify data and features, such as an account number associated with the bill, customer name associated with the bill, amount of the bill, due date of the bill, etc. Additional information may be obtained through parsing without departing from the invention. The information received may be recognized by a bill-pay system (such as system 206) and may be used to identify and/or complete electronic funds transfers through the bill-pay system.

In other examples, a mobile device may be used to scan or photograph a bill or statement that could be parsed to obtain bill-pay information. This may be performed using a mobile banking application, etc. In some examples, the scan or photo of the bill may be parsed at the mobile device or may be transmitted to an application, for instance, a bill-pay setup application housed at the financial institution.

In other examples, the scanned image or photograph may include a 2-D bar code, QR code, etc. that may be recognized and may provide bill-pay setup information associated with that bill-pay client. For instance, a bar code may include information such as name of the bill-pay client, name of the customer, account number of the customer, amount of bill, etc. This information may be obtained from the 2-D bar code and used to setup bill-pay for the customer with limited or no further interaction from the customer.

As discussed above, GPS or other location information may be used to obtain bill-pay setup information (in addition to being used to identify bill-pay clients). For example, a user may, upon entering a merchant, service provider, etc. (such as a doctor's office, retailer, etc.) desire to capture data for setting up automatic bill-pay for this merchant. The user may use a mobile device, such as via a mobile banking widget or other application, and identify the GPS coordinates of the user and corresponding data available from online services, such as GOOGLE MAPS, etc. This information may be used in the automatic bill-pay setup process. For instance, the GPS coordinates, and data identified via those coordinates, may provide information such as merchant name, billing address of the merchant, frequency of billing, type of services or goods provided, etc. A user or customer may then complete the bill-pay setup process by verifying information, such as an account number with the merchant, amount of payment, due date, etc.

In other examples, the user may photograph a sign or other entrance/address identifier of a merchant to obtain identifying information (e.g., via GPS, etc.) and may then provide account information, etc. to set up bill-pay. The account information may include name or merchant, billing address, etc.

Bill-pay setup information may also be obtained from current or previous transaction information obtained via a transaction between the customer and a bill-pay client. For instance, during a web or online purchase, a user may be prompted, such as during checkout, to sign up for automatic bill-pay with that bill-pay client. In this arrangement, the bill-pay setup information may be obtained during the checkout process and stored in the bill-pay system for future use. The automatic bill-pay system may prompt a user at checkout to sign up for automatic bill-pay or, additionally or alternatively, the offer to set up bill-pay may be transmitted to the user at a later time, such as via email, SMS, etc.

Additionally or alternatively, radio frequency identifier tag (RFID), BLUETOOTH, and/or Near Field Communication (NFC) data associated with an identified bill-pay client may be identified and used to complete bill-pay setup. For example, a customer may use mobile payment NFC at a point-of-sale system at a retailer. Mobile payment NFC may include presenting a mobile device within a predefined proximity to a point of sale system in order to complete a transaction (e.g., provide payment, etc.). The payment information used to complete the transaction (e.g., name of retailer, account associated with retailer, etc) may then be stored and used to set up automatic bill-pay for a user. That is, the data obtained regarding the retailer, including name, account information, etc. may be transferred to a bill pay system and a user may be provided with an option to automatically set up bill-pay with that retailer using the data already stored in the bill-pay system.

In yet another example, bill-pay information may be obtained through connections of the customer, such as via social networking sites, such as FACEBOOK, TWITTER, etc. For instance, a customer of the financial institution or other user may be connected to person A via FACEBOOK. Person A may have bill-pay setup with Bill-Pay Client A. The automatic bill-pay setup system may then offer to set up bill-pay to the customer and may use the bill-pay information obtained from person A for setup.

Although several aspects have been described with respect to individual customers of a financial institution, automatic bill-pay setup may also be used with business customers, such as small business owners, etc. For example, automatic bill-pay setup and associated features may also be used by small businesses to set up bill-pay vendor payments or bill-pay vendor selection based on vendors identified as being used with other similar small businesses, within a geographic area, etc. Similar to the arrangements discussed above, a zip code or other region or area identifier may be used to identify vendors within a region and small businesses within that region may then be offered bill-pay options associated with one or more of the vendors.

In still other examples, the automatic bill-pay option may be provided as an incentive to encourage customers to move their bank accounts to the financial institution offering the automatic bill-pay option. For instance, if a couple has accounts at more than one financial institution, some bills might be paid through Bank 1 while others might be paid through Bank 2. Bank 1 may offer automatic bill-pay but only for the services paid through the Bank 1 account. Thus, if the couple consolidated accounts at Bank 1, or opened additional accounts at Bank 1, additional bill-pay options could be offered based on most or all bills being paid through Bank 1.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. A method, comprising:
identifying, by a bill-pay system of a financial institution, a first customer eligible for a bill-pay transaction with a bill-pay client;
offering, by the bill-pay system, an option to accept bill-pay setup between the identified first customer and the bill-pay client; and
responsive to receiving user input accepting the bill-pay option, automatically setting up, by the bill-pay system, the bill-pay transaction between the identified first customer and the bill-pay client.

2. The method of claim 1, wherein identifying the customer eligible for the bill-pay transaction includes receiving data associated with the customer.

3. The method of claim 1, wherein automatically setting up the bill pay transaction includes identifying and implementing, by the bill-pay system, a plurality of bill-pay default settings.

4. The method of claim 1, wherein automatically setting up the bill-pay transaction includes receiving, at the bill-pay system, bill-pay settings associated with the bill-pay client from a second customer having a preexisting bill-pay relationship with the bill-pay client.

5. The method of claim 1, wherein automatically setting up the bill-pay transaction includes receiving, at the bill-pay system, at least one of a scan and photograph of a bill including bill-pay transaction information.

6. The method of claim 5, further including parsing the at least one of a scan and photograph to identify the bill-pay transaction information and implementing the bill-pay transaction information as bill-pay settings to automatically setup bill-pay between the first customer and the bill-pay client.

7. The method of claim 1, wherein automatically setting up the bill-pay transaction includes determining a location of a mobile device of the first customer and receiving bill-pay transaction information for the bill-pay client at the location of the mobile device of the first customer.

8. The method of claim 7, wherein the location of the mobile device of the first customer is based on a global positioning system (GPS).

9. The method of claim 7, wherein the bill-pay transaction information is receiving during a transaction between the first customer and the bill-pay client.

10. A method, comprising:
receiving, by a bill-pay system of a financial institution, a customer eligible for a bill-pay transaction, the customer being associated with the financial institution;
receiving, by the bill-pay system, a bill-pay client with which a bill-pay transaction is being setup between the customer and the bill-pay client;
receiving, by the bill-pay system, bill-pay transaction information; and
automatically setting up the bill-pay transaction between the customer and the bill-pay client based on the received bill-pay transaction information.

11. The method of claim 10, wherein the bill-pay transaction information includes default settings associated with the bill-pay system and the bill-pay client.

12. The method of claim 10, wherein the bill-pay transaction information includes at least one of a photograph and scan of a bill associated with the bill-pay transaction.

13. The method of claim 10, further including identifying a plurality of individuals associated with the customer on a social networking site, and receiving bill-pay transaction information from an existing bill-pay relationship between at least one individual associated with the customer and the bill-pay client.

14. The method of claim 10, wherein the bill-pay client is at least one of a utility company, grocer, retailer, water delivery company, newspaper delivery company, and child care provider.

15. One or more non-transitory computer readable media storing computer readable instructions that, when executed, cause an apparatus to:
identify, by a bill-pay system of a financial institution, a first customer eligible for a bill-pay transaction with a bill-pay client;
offer, by the bill-pay system, an option to accept bill-pay setup between the identified first customer and the bill-pay client;
responsive to receiving user input accepting the bill-pay option, receive, by the bill-pay system, bill-pay transaction information associated with the bill-pay client; and
automatically set up, by the bill-pay system, the bill-pay transaction between the identified first customer and the bill-pay client.

16. The one or more non-transitory computer readable media of claim 15, wherein receiving the bill pay transaction information and automatically setting up the bill-pay transaction further includes receiving, by the bill-pay system, bill-pay settings associated with the bill-pay client from a second customer having a preexisting bill-pay relationship with the bill-pay client.

17. The one or more non-transitory computer readable media of claim 15, wherein receiving bill-pay transaction information includes receiving, at the bill-pay system, at least one of a scan and photograph of a bill including bill-pay transaction information.

18. The one or more non-transitory computer readable media of claim 17, further including parsing the at least one of a scan and photograph to identify the bill-pay transaction information and implementing the bill-pay transaction information as bill-pay settings to automatically setup bill-pay between the first customer and the bill-pay client.

19. The one or more non-transitory computer readable media of claim 15, wherein receiving bill-pay transaction information includes determining a location of a mobile device of the first customer and receiving bill-pay transaction information for the bill-pay client at the location of the mobile device of the first customer.

20. The one or more non-transitory computer readable media of claim 19, wherein the location of the mobile device of the first customer is based on a global positioning system (GPS).

21. An apparatus comprising:
a processor; and
memory operatively coupled to the processor and storing computer readable instructions that, when executed, cause the apparatus to:
identify, by a bill-pay system of a financial institution, a first customer eligible for a bill-pay transaction with a bill-pay client;
offer, by the bill-pay system, an option to accept bill-pay setup between the identified first customer and the bill-pay client;
responsive to receiving user input accepting the bill-pay option, receive, by the bill-pay system, bill-pay transaction information associated with the bill-pay client; and
automatically set up, by the bill-pay system, the bill-pay transaction between the identified first customer and the bill-pay client.

22. The apparatus of claim 21, wherein receiving the bill pay transaction information and automatically setting up the bill-pay transaction further includes receiving, by the bill-pay system, bill-pay settings associated with the bill-pay client from a second customer having a preexisting bill-pay relationship with the bill-pay client.

23. The apparatus of claim 21, wherein receiving bill-pay transaction information includes receiving, at the bill-pay system, at least one of a scan and photograph of a bill including bill-pay transaction information.

24. The apparatus of claim 23, further including parsing the at least one of a scan and photograph to identify the bill-pay transaction information and implementing the bill-pay transaction information as bill-pay settings to automatically setup bill-pay between the first customer and the bill-pay client.
